(19) United States
(12) Patent Application Publication
(10) Pub. No.: US 2024/0057521 A1
(43) Pub. Date: Feb. 22, 2024

(54) SEPARATING DEVICE, COMBINE HARVESTER WITH A SEPARATING DEVICE, AND METHOD FOR SEPARATING WEED SEEDS AND LOST CROPS FROM THE WASTAGE OUTFLOW OF A HARVESTING MACHINE

(71) Applicants: ZÜRN HARVESTING GMBH & CO. KG, Schöntal-Westernhausen (DE); PETKUS TECHNOLOGIE GMBH, Wutha-Farnroda (DE)

(72) Inventors: Thomas HERLITZIUS, Dresden (DE); Samuel PANTKE, Dresden (DE); Rolf ZÜRN, Schöntal-Westernhausen (DE); Mark SCHOLZE, Wutha-Farnroda (DE); Andreas HÄNSEL, Wutha-Farnroda (DE); Henri SCHOLTKE, Schöntal-Westernhausen (DE); Florian LÖCKLE, Schöntal-Westernhausen (DE)

(73) Assignees: ZÜRN HARVESTING GMBH & CO. KG, Schöntal-Westernhausen (DE); PETKUS TECHNOLOGIE GMBH, Wutha-Farnroda (DE)

(21) Appl. No.: 18/258,269

(22) PCT Filed: Dec. 17, 2021
(86) PCT No.: PCT/EP2021/086532

§ 371 Date: Jun. 19, 2023

(30) Foreign Application Priority Data
Dec. 18, 2020 (DE) 10 2020 134 150.4

(51) Int. Cl. A01D 41/12; A01F 12/44

(52) U.S. Cl. CPC A01D 41/1243; A01F 12/44

(57) ABSTRACT

The invention relates to a separating device (3) and to a separating method for separating weed seeds and lost crops from the wastage outflow (102) of a harvesting machine (1). The separating device (3) is arranged on the harvesting machine (1) to the outlet area for the wastage (2) of the harvesting machine (1) and has at least one rotating separating element (31), with which a material stream substantially consisting of weed seeds and lost crops is separated from the wastage outflow (102) of the harvesting machine (1). The remaining material stream (103) substantially consists of non-grain constituents and can be spread back directly onto the field, while the separated material stream substantially consisting of weed seeds and lost crops can first be collected and e.g. rendered unable to germinate.

The invention relates to a separating device, a combine harvester with a separating device, and a method for separating weed seeds and lost crops from the wastage outflow of a harvesting machine.

The material remaining after separation of the harvested crops in a cleaning system of a harvesting machine, hereinafter referred to as wastage outflow, contains, in addition to plant constituents of the harvested crops, weed seeds (BKS), including seeds of grasses and herbs, and/or lost crops. With conventional harvesting machines, the wastage outflow is completely spread back onto the harvested field. While the spreading of plant constituents to the harvested field is unproblematic or desired and can contribute to humus formation, the spreading of BKS and lost crops is undesirable for reasons of field hygiene, since, for example, increased post-harvest expenditures due to active tillage measures or plant protection agents against emerging crop and weed plants have to be applied.

Plant constituents of the harvested crops, which are a by-product of the harvesting of the harvested crops, are hereinafter referred to as “non-grain constituents” (NKB), wherein “grain” in the context of the present invention is to be understood as a general term for the part of the harvested crops intended for harvesting, e.g. cereal grains, rapeseed grains, corn grains, soybeans. NKB may comprise, for example, chaff, short straw, husks, spindles, etc.

It is therefore desirable to separate BKS and lost crops from the wastage outflow and, for example, to dispose of them separately. For this purpose, the prior art proposes, on the one hand, separation units that have drum screen systems. Drum screens can have several advantages over other devices for classifying bulk materials, such as flat vibrating screens or air classifiers, in particular high throughput, robustness against variable operating conditions, e.g. in slope operation, a long service life, a compact design, and comparatively low purchase and maintenance costs.

For example, DE 1 407 859 A addresses a machine for cleaning and sorting cereal grains fed, for example, by a combine harvester, whereby said cereal grains fall from a distribution hopper into a drum screen after being pre-cleaned by means of a controllable cross-air flow created by suction. Other similar separation units or methods for BKS separation are disclosed, for example, in US 2011/0 059 782 A1 and AU 2011/265 350 A1.

The disadvantage of these systems is that they are arranged spatially separated from the harvesting machine, e.g. they are permanently installed in one place or track the harvesting machine. The aforementioned systems must therefore have their own drive, for example.

On the other hand, the prior art addresses separation units that are arranged on the harvesting machine downstream of the cleaning process.

The use of flat screens is known for separating BKS on combine harvesters. For example, DE 3 540 493 C1 describes a combine harvester having a flat screen arrangement for separating BKS, which are subsequently fed to a beater mill together with the chaff. DE 4 209 503 C2 describes a combination of at least one rigid or movable flat screen for BKS separation. RU 2 286 045 C2 shows a three-stage flat screen arrangement for this purpose. Further screen arrangements for BKS separation are shown in U.S. Pat. Nos. 3,580,257 A and 5,059,154 A.

Also known are solutions for separating BKS on combine harvesters by means of an air stream. For example, RU 2 419 278 C1 describes separation by means of an air classifier, and DE 10 2010 032 156 B4 discloses the separation of BKS from a classifier air stream by means of baffle plates.

DE 24 13 975 A describes a grain separator in which a threshed crop containing grain is passed over a sieve performing oscillating movements to separate the grains from the rest of the crop. The grain separator has a rotor, which has different, but respectively constant radial distances, which are separated from the axis of the rotor shaft. An associated drive apparatus operates without slip to cause timing of the rotational movement of the rotor to the movements of a screen such that a gap of substantially constant width is maintained while the screen performs oscillating movements.

Document U.S. Pat. No. 1,564,585 A discloses a combination of a weed screen with a conveyor. This combination comprises a housing having a shaft extending to the conveyor and having a spiral conveyor thereon; a screw on the shaft which cooperating with the spiral conveyor to advance material; a screen drum surrounding the screw; and an apparatus, independent of the screw, for rotating the drum in a direction opposite to that of the screw.

EP 0 250 654 A1 discloses a modular combine harvester comprising a threshing module, a separation module and a cleaning module, which are operationally detachably connected to one another. One or more of the modules mentioned are designed to be interchangeable with another module of a different type.

Compared to drum screening systems, the separation solutions mentioned above, which are intended for integration into a harvesting machine, have the disadvantages mentioned above.

To date, there is no known solution for separating BKS and lost crops from the wastage of a harvesting machine that offers the advantages of drum screen systems, such as high throughput, robustness against variable operating conditions, e.g. in slope operation, a long service life, a compact design, and comparatively low acquisition and maintenance costs, in a separation unit arranged on the harvesting machine.

The object of the invention is therefore to overcome the disadvantages of the prior art and to provide a device and a method for separating BKS and lost crops directly from the wastage outflow of a harvesting machine.

The object is solved by a separating device for arrangement on, i.e. integration in, a harvesting machine, wherein the separating device can be arranged on the outlet area for the wastage of the harvesting machine, i.e. in particular can be materially connected to the outlet area of the harvesting machine. According to the invention, the separating device is directly associated with the harvesting machine. The separating device has at least one rotating separating element, which can be used to separate a material stream substantially consisting of weed seeds (BKS) and lost crops from the wastage outflow of the harvesting machine.

The wastage outflow of the harvesting machine substantially contains NKB, BKS and lost crops. From this material stream, which may correspond to a large mass stream of several t/h, e.g. 20 t/h, a particulate material stream substantially consisting of BKS and lost crops is separated by means of the at least one rotating separation element of the separation device. The wastage outflow can thereby be separated into a particulate material stream substantially consisting of NKB, which e.g. can be spread back onto the harvested field, and a particulate material stream substantially consisting of BKS and lost crops, which e.g. is not spread back onto the harvested field again, but e.g. is collected separately.

The invention thus contributes to a significant improvement in field hygiene.

It is obvious to the person skilled in the art that “substantially” in the sense of the invention means in each case that it is not excluded that a material stream may also contain, in addition to the essential constituents mentioned, foreign constituents in smaller numbers, preferably in much smaller numbers, than the essential constituents, e.g. in a low two-digit percentage range, preferably in a single-digit percentage range relative to the total material stream. In particular, it is not excluded that the separated material stream substantially consisting of BKS and lost crops may also contain a small amount of NKB.

In the context of this description, the term “at least one” is used for brevity, which can mean: one, exactly one, several (e.g. exactly two, or more than two), many (e.g. exactly three, or more than three), etc. Here, “several” or “many” need not necessarily mean that there are several or many identical elements, but several or many substantially functionally identical elements.

Preferably, the separating device according to the invention can be arranged on the harvesting machine, i.e. integrated into the harvesting machine, in such a way that the drive of the separating device, e.g. for rotation of the separating element, is effected by means of the drive of the harvesting machine. The separating device therefore preferably does not require a separate drive.

In an embodiment of the invention, the rotating separating element is designed to separate the material stream substantially consisting of BKS and lost crops from the wastage outflow of the harvesting machine based on the dimensions or mass or fluid dynamic properties of the particles of the wastage outflow or based on a combination of the aforementioned properties.

In a further embodiment of the separating device according to the invention, the rotational movement of the separating element is superimposed with a vibrating and/or oscillating movement advantageously supporting its separating function.

In a further embodiment of the separating device according to the invention, a blower is arranged below the rotating separating element, whereby the wastage outflow in the rotating separating element is pneumatically loosened up and light constituents are exposed, so that advantageously a better separation efficiency can be achieved.

In a further embodiment of the separating device according to the invention, at least one conveying element is arranged upstream or downstream of the at least one rotating separating element for supporting the material flow. A conveying element can also be arranged both upstream and downstream of the rotating separating element.

A conveying movement of the mass stream to be separated is also given by the rotation of the separating element.

The at least one conveying element may be a passive conveying element, such as an inclined chute. Preferably, at least one conveying element is designed as an active conveying element, e.g. a conveyor belt, conveyor roller, vibrating plate, blower, etc. The conveying element can also have a combination of active and passive means, e.g. be an inclined conveyor belt.

In a further embodiment, the separating device according to the invention has at least two rotating separating elements to increase the separation efficiency. The at least two rotating separating elements are arranged in series with respect to the material stream. At least one conveying element is arranged between the at least two rotating separating elements, preferably an active conveying element, e.g. a conveyor belt, a conveyor roller, a vibrating plate, a blower, etc.

In a further embodiment of the separating device according to the invention, a discharge area is arranged at the outlet on the passage side of the at least one rotating separating element, which discharges into a collection area for the material stream consisting substantially of BKS and lost crops. The discharge area may comprise, for example, a pipe system that is blown out by means of a blower. Accordingly, the separated material stream substantially consisting of BKS and lost crops can be pneumatically conveyed to the collection area.

The collection area may be a container in which the BKS and lost crops are collected in order to be put to secondary use, for example.

If the material stream contains predominately lost crops and only a small amount of BKS, it is possible to feed it back to the harvested crops in the sense of lost crop recovery.

The collection area may have a device for rendering the BKS and lost crops unable to germinate, e.g. a grinding system, such as a hammer mill, and/or a device for thermal treatment and/or treatment with microwaves, etc. Advantageously, the germination-incapable material stream can subsequently be spread back onto the field in a harmless manner.

In a further embodiment of the separating device according to the invention, a decoupling unit for decoupling the rotating separating element and the conveying element is arranged at least at the outlet on the passage side of the rotating separating element. Advantageously, the separating function can thus be ensured independently of the conveying function of the conveying element. The decoupling unit can preferably be a star feeder.

In a further embodiment, the separating device according to the invention is of modular design. In this case, components of the separating device are connected to one another and can be detachably connected to a harvesting machine in such a way that the separating device can be removed from the harvesting machine as a module. Advantageously, the separating device can form an independent functional unit that can be mounted on the harvesting machine if required. Furthermore, existing harvesting machines can be retrofitted with the separating device module.

In a further embodiment, the rotating separating element of the separating device according to the invention is a drum screen. In particular, screening of the wastage outflow allows classification based on characteristic lengths of the particles in the wastage outflow. Drum screens are generally characterized by high throughput, robustness against variable operating conditions, a long service life, a compact design, and comparatively low purchase and maintenance costs.

Preferably, the drum screen is loaded from the outside, i.e. fed on its outer side with the wastage outflow of the harvesting machine. Particles in the wastage outflow that are smaller than the screen holes in a suitable position as they move across the outside of the drum screen can pass through them and enter the inside of the drum screen. According to the invention, the screen underflow, substantially consisting of BKS and lost crops, does not return to the field without further treating, but e.g. to a collection area, while the screen overflow, substantially consisting of NKB, can be spread back onto the field again.

In a preferred embodiment of the invention, the drum screen has replaceable screen elements. Different screen elements can have different screen hole sizes, e.g. screen hole diameters or screen hole lengths. The screen hole size of a screen element is selected depending on the type of wastage outflow, e.g. the type of crop. The selected screen hole size may depend, for example, on the dimensions of the NKB and/or the BKS and/or the lost crops. The separating device according to the invention is thus advantageously suitable for use when harvesting various types of crops, wherein a large number of different BKS can be separated from the wastage outflow.

The separating device according to the invention may have several, e.g. two, drum screens, which are successively passed by the material to be screened. In this regard, the plurality of drum screens may have different rotational speeds or rotational directions or drum diameters from one another, or any combination of the aforementioned properties that are different from one another. However, the properties mentioned may be the same for some or all of the plurality of drum screens. Likewise, the plurality of drum screens may have different or the same screen hole sizes from one another.

In a preferred embodiment, the separating device according to the invention has at least two drum screens arranged one after the other as rotating separating elements, between each of which at least one active conveyor element is arranged, and of which the rotational speed or direction of rotation or drum diameter or screen hole sizes or a combination of the aforementioned can be the same or different from one another. Advantageously, this design enables a particularly thorough separation into NKB and BKS as well as lost crops, adapted to the type of material to be screened out. Furthermore, the use of at least one active conveying element ensures reliable crop flow. The material to be screened is additionally conveyed by the rotation of the drum screens.

Another aspect of the invention relates to a combine harvester on which the separating device according to the invention is arranged.

In an embodiment of the combine harvester according to the invention, the axis of rotation of the rotating separating element of the separating device is arranged transversely to the longitudinal vehicle axis of the combine harvester, i.e. transversely to the direction of travel of the combine harvester. Advantageously, the separating device according to the invention can thus be designed to be particularly compact. Due to its compact design, the separating device can be arranged on the combine harvester in such a manner that it interferes as little as possible with the intended material flow of the wastage outflow, i.e. in such a way that the separating device does not exert any negative influence on the material stream in the combine harvester. For example, the NKB distributor (usually referred to as the “chaff spreader”) of the combine harvester can continue to function as intended.

The invention also relates to a method for separating BKS and lost crops from the wastage outflow of a harvesting machine, having at least the following method steps:
i. feeding the wastage outflow to a separating device arranged on the harvesting machine, i.e. integrated into the harvesting machine, and having at least one rotating separating element;
ii. separating the wastage outflow with at least one rotating separating element of the separating device into a material stream substantially consisting of weed seeds and lost crops and a material stream substantially consisting of non-grain constituents;
iii. feeding the material stream substantially consisting of weed seeds and lost crops to a collection area and discharging the material stream substantially consisting of non-grain constituents onto the field.

The method according to the invention can be carried out with a separating device in accordance with one or a combination of the above embodiments.

The method according to the invention contributes to an improvement of field hygiene, as the discharge of BKS and lost crops affecting field hygiene onto the field is significantly reduced.

In an embodiment of the method according to the invention, the separation of the wastage outflow in method step ii. is performed based on the dimensions or the mass or the fluid dynamic properties of the particles of the wastage outflow or based on a combination of at least two of the aforementioned properties of the particles of the wastage outflow.

The method according to the invention is particularly suitable for use on a self-propelled harvesting machine in the sense of integration in a self-propelled harvesting machine, preferably a combine harvester.

The invention is not limited to the illustrated and described embodiments, but also includes all embodiments which act identically within the meaning of the invention. Furthermore, the invention is also not limited to the specifically described feature combinations, but may also be defined by any other combination of particular features of all individual features disclosed overall, provided the individual features are not mutually exclusive, or a specific combination of individual features is not explicitly excluded.

The invention is explained below by means of exemplary embodiments with reference to figures, without being limited thereto.

In the drawings:

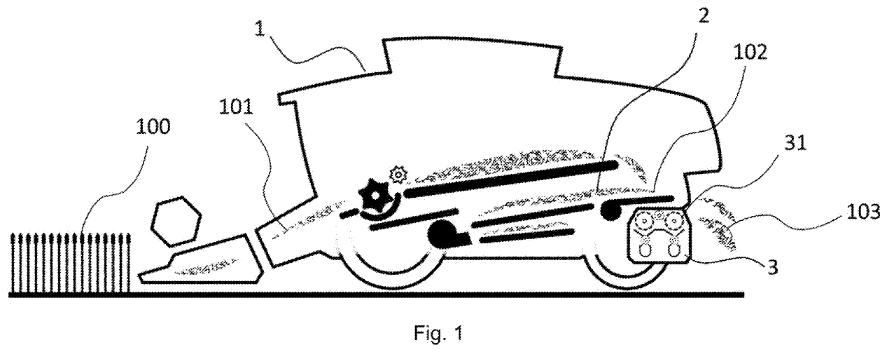

FIG. 1 shows a combine harvester on which the separating device according to the invention is arranged,

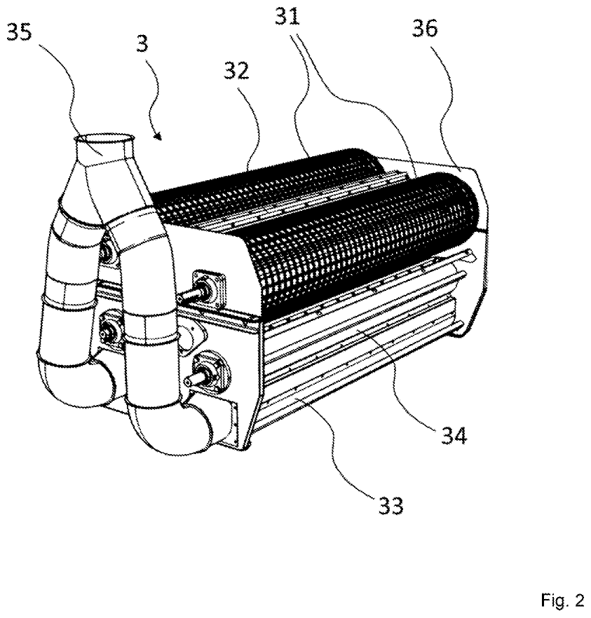

FIG. 2 shows a perspective view of a separating device according to the invention, and

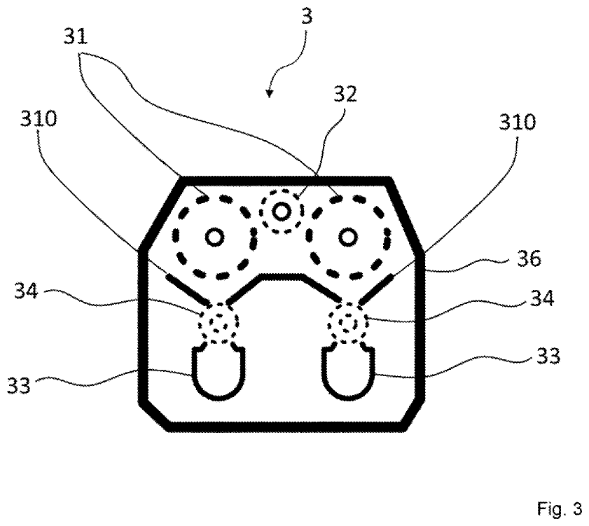

FIG. 3 shows a cross-section perpendicular to the axis of rotation of the drum screens of a separating device according to the invention.

FIG. 1 shows a combine harvester 1 harvesting crop plants 100. After threshing, the crop 101, which contains the harvested crops, NKB, BKS, and lost crops, reaches cleaning 2, which is used to separate the harvested crops from the crop 101. The wastage outflow 102 is fed to the separating device 3, which is arranged on the combine harvester 1 and is also driven by the drive of the combine harvester 1. In the separation device 3, the wastage outflow 102 is separated into a material stream 103 consisting substantially of NKB, which is returned to the harvested field, and a material stream consisting substantially of BKS and lost crops (not shown), which first enters a collection area (not shown). The separating device 3 is arranged on the combine harvester 1 in such a manner that the axis of rotation of the rotating separating elements in the form of two drum screens 31 is transverse to the direction of travel or transverse to the longitudinal axis of the combine harvester 1.

FIG. 2 shows a separating device 3 according to the invention, which is intended for arrangement on a self-propelled harvesting machine, in particular a combine harvester. The separating device 3 comprises two drum screens 31, which are connected to an active conveying element in the form of a conveyor roller 32 and are successively passed by the material to be screened out (not shown).

The wastage outflow (not shown) from the combine harvester falls from above onto the outer surface of a first of the two drum screens 31. The constituents of the wastage outflow that are larger than the screen holes of the drum screens 31 or have not passed the screen holes for other reasons, i.e. the screen overflow, do not enter the inside of the first of the drum screens 31, but are conveyed further by the rotation of the first of the drum screens 31, resting on its outer surface, to the conveyor roller 32, with the aid of which the screen overflow of the first of the drum screens is transported to the outside of the second of the two drum screens 31 and classified again as described above.

The constituents of the wastage outflow which are smaller than the screen holes of the first of the two drum screens 31 (screen underflow), i.e. substantially BKS and lost crops, can pass through the screen holes of the first of the drum screens 31 and enter a trough-shaped conveyor channel 33 arranged below the drum screens 31, which is decoupled from the respective drum screen 31 by means of a star feeder 34.

The screen overflow of the second of the two drum screens 31 substantially consists of NKB and may, for example, be in communication with the chaff spreader of the combine harvester.

The screen underflow is transported in the conveying channels 33 to a discharge area in the form of a piping 35, e.g. by an air flow, wherein the piping may be in communication with a collection container, for example, in which the BKS and lost crops are collected until further treatment.

The housing 36 surrounding the separating device 3 is indicated.

FIG. 3 shows a section perpendicular to the axis of rotation of the two drum screens 31 through the separating device 3 of FIG. 2, such that the drum screens 31, the conveyor roller 32, the conveyor channels 33 and the star feeder 34 are shown in cross-section. Collecting troughs 310 are arranged below the drum screens 31.

### REFERENCE SIGNS

1 combine harvester
100 crop plant
101 crop
102 wastage outflow
103 screen overflow
2 cleaning
3 separating device
31 separating element, drum screen
310 collecting trough
32 conveyor roller
33 conveyor channel
34 star feeder
35 piping
36 housing

1. A separating device (3) for arrangement on a harvesting machine (1), characterized in that the separating device (3) can be arranged at the outlet area for the wastage (2) of the harvesting machine (1) and has at least one rotating separating element (31), with which a material stream substantially consisting of weed seeds and lost crops is separated from the wastage outflow (102) of the harvesting machine (1).

2. The separating device (3) according to claim 1, characterized in that the separating device (3) has at least one conveying element (33) upstream or downstream of the rotating separating element (31) or a combination of both.

3. The separating device (3) according to claim 2, characterized in that a decoupling unit (34) for decoupling the rotating separating element (31) and the conveying element (33) is arranged at least at the outlet on the passage side of the rotating separating element (31).

4. The separating device (3) according to claim 1, characterized in that the separating device (3) has at least two rotating separating elements (31), between which at least one conveying element (32) is arranged.

5. The separating device (3) according to claim 1, characterized in that a discharge area is arranged at the outlet on the passage side of the rotating separating element (31), which discharge area opens into a collection area for the material stream substantially consisting of weed seeds and lost crops.

6. The separating device (3) according to claim 1, characterized in that the separating device (3) is modular, wherein components of the separating device (3) are connected to one another and can be detachably connected to the harvesting machine (1) such that the separating device (3) can be removed from the harvesting machine (1) as a module.

7. The separating device (3) according to claim 1, characterized in that the rotating separating element (31) is a drum screen.

8. The separating device (3) according to claim 7, characterized in that the drum screen (31) is loaded from the outside with the wastage outflow (102) of the harvesting machine (1).

9. The separating device (3) according to claim 8, characterized in that the drum screen (31) has exchangeable screen elements.

10. The separating device (3) according to claim 8, characterized in that the separating device (3) has at least two drum screens (31) arranged one after the other as rotating separating elements, between each of which at least one conveying element (32) is arranged, and of which the rotational speed or direction of rotation or drum diameter or screen hole sizes or a combination of the aforementioned can be the same or different from one another.

11. A combine harvester (1) having a separating device (3) according to claim 1.

12. The combine harvester (1) according to claim 11, characterized in that the axis of rotation of the rotating separating element (31) of the separating device (3) is arranged transversely to the longitudinal vehicle axis of the combine harvester (1).

13. A method for separating weed seeds and lost crops from the wastage outflow (102) of a harvesting machine (1), having at least the following method steps:
i. feeding the wastage outflow (102) to a separating device (3) arranged on the harvesting machine (1) and having at least one rotating separating element (31);
ii. separating the wastage outflow (102) with at least one rotating separating element (31) of the separating device (3) into a material stream substantially consisting of weed seeds and lost crops and a material stream (103) substantially consisting of non-grain constituents;
iii. feeding the material stream substantially consisting of weed seeds and lost crops to a collection area and discharging the material stream (103) substantially consisting of non-grain constituents onto the field.
